(19) United States
(12) Patent Application Publication
(10) Pub. No.: US 2026/0051690 A1
(43) Pub. Date: Feb. 19, 2026

(54) CONNECTOR APPARATUS FOR VEHICLE

(71) Applicant: HYUNDAI MOBIS CO., LTD., Seoul (KR)

(72) Inventors: Un Yong SONG, Yongin-si (KR); Jae Seung LEE, Yongin-si (KR); Tae Mun MIN, Yongin-si (KR); Ju Ham SON, Yongin-si (KR)

(73) Assignee: HYUNDAI MOBIS CO., LTD., Seoul (KR)

(21) Appl. No.: 19/230,350

(22) Filed: Jun. 6, 2025

(30) Foreign Application Priority Data
Aug. 13, 2024 (KR) 10-2024-0108005

(51) Int. Cl. H01R 13/502

(52) U.S. Cl. CPC H01R 13/502; H01R 2201/26

(57) ABSTRACT

A connector apparatus for a vehicle and a system therefor are provided. The connector apparatus includes a casing, a male connector disposed on a first side of the casing, the male connector including a first coupler, and a connector block disposed on a second side of the casing, and including a second coupler attached to an interlocking wire. The casing is formed with a through hole through which the second coupler passes. The male connector and the connector block are arranged to be separated with the casing interposed therebetween. The male connector is separated from the interlocking wire and is configured to come in contact with the second coupler through the through hole.

### CROSS-REFERENCE TO RELATED APPLICATION(S)

This application claims the benefit under 35 USC § 119(a) of Korean Patent Application No. 10-2024-0108005, filed on Aug. 13, 2024, in the Korean Intellectual Property Office, the entire disclosure of which is hereby incorporated by reference for all purposes.

### BACKGROUND

### 1. Field

The disclosure relates to a connector apparatus for a vehicle.

### 2. Description of the Related Art

The disclosure relates to a connector apparatus for a vehicle.

### SUMMARY

An aspect of the disclosure is to enable the separation of a male connector without disassembling a casing, in order to solve problems such as the inseparability of the male connector due to an interlocking wire, the breakage of the interlocking wire due to pulling force upon separation, and damage to the sheath of the interlocking wire chewed between the male connector and surrounding components when coupled.

In a general aspect of the disclosure, a connector apparatus for a vehicle, the connector apparatus includes, a casing, a male connector disposed on a first side of the casing, the male connector including a first coupler; and a connector block disposed on a second side of the casing, and including a second coupler attached to an interlocking wire, wherein the casing is formed with a through hole through which the second coupler passes, wherein the male connector and the connector block are arranged to be separated with the casing interposed therebetween, and wherein the male connector is separated from the interlocking wire and is configured to come in contact with the second coupler through the through hole.

The male connector may be further configured to come in contact with only the second coupler through the through hole.

The second coupler may be configured to protrude from the connector block and insert into the through hole while passing through the through hole.

The second coupler may be configured to extend longer than the thickness of the casing and protrude to be exposed to the first side of the casing.

The second coupler may be formed with a coupling groove, wherein the interlocking wire may be configured to extend into the coupling groove.

The coupling groove may be configured to extend to the first side of the casing.

The connector apparatus may further include a female connector configured to couple with the male connector.

The interlocking wire may be configured to couple to and penetrate the connector block.

The connector apparatus of claim 1, wherein a surface where the connector block is installed is sealed by the casing.

The second coupler may include a hook, wherein the first coupler may include a protrusion configured to couple with the hook.

The through hole may be equivalent in size to a cross-section of the second coupler, and smaller than a cross-section of the connector block.

In another general aspect of the disclosure, a connector system for a vehicle includes: a casing including a through hole; a male connector disposed on a first side of the casing, the male connector including a first coupler; a connector block disposed on a second side of the casing and including a second coupler that extends through the through hole toward the male connector; and an interlocking wire attached to the second coupler and extending through the connector block at the second side of the casing, wherein the first coupler and the second coupler are configured to attach to each other to interconnect the male connector and the connector block, and wherein the male connector and the connector block are separated by the casing interposed therebetween.

The male connector may be configured to come in contact with a portion of the second coupler that extends through the through hole.

The first coupler and the second coupler may be further configured to detachably attach to each other.

The first coupler and the second coupler may be attached via a connection that includes a hook, a coupling groove, and a protrusion.

The first coupler may include the protrusion and the second coupler may include the protrusion and the insertion groove, wherein the hook may be inserted into the coupling grove and interlocked with the protrusion.

The second coupler may be formed with a coupling groove, wherein the interlocking wire may be configured to extend into the coupling groove.

The connector apparatus may further include a female connector configured to couple with the male connector.

### BRIEF DESCRIPTION OF THE DRAWINGS

FIG. 1 is a disassembled diagram of a connector apparatus for a vehicle according to the disclosure.

FIG. 2 is an assembled diagram of the connector apparatus of FIG. 1.

FIG. 3 is a diagram illustrating that a connector block is installed on a second side of a casing.

FIG. 4 is a diagram illustrating a first coupler and a second coupler.

### DETAILED DESCRIPTION

Below, exemplary embodiments of the disclosure will be described with reference to the accompanying drawings.

In the following description, the size, shape, etc. of components depicted in the accompanying drawings may be exaggerated for clarity and convenience of description. Further, terms specially defined in consideration of the configuration and function of the disclosure may vary depending on the intention or custom of a user or operator. The definitions of these terms should be made based on the description throughout this specification.

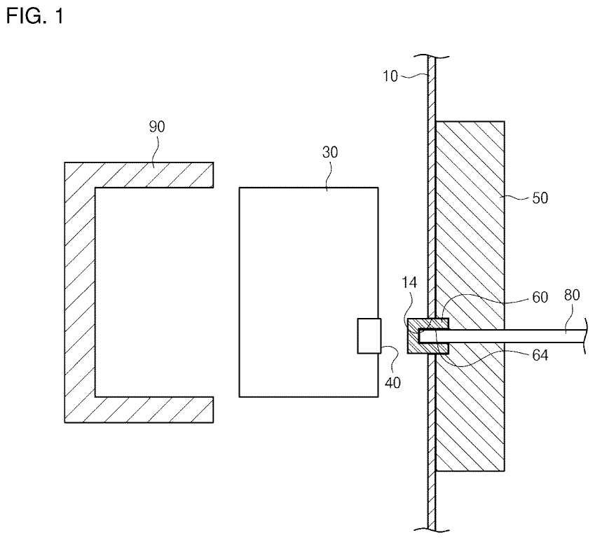

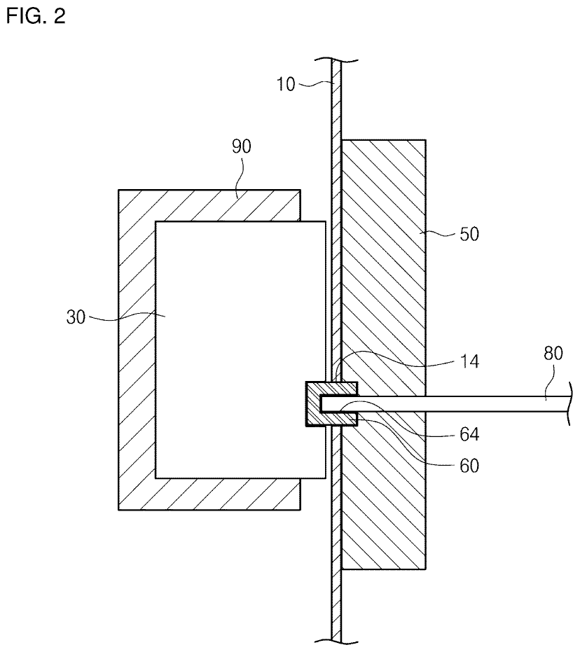

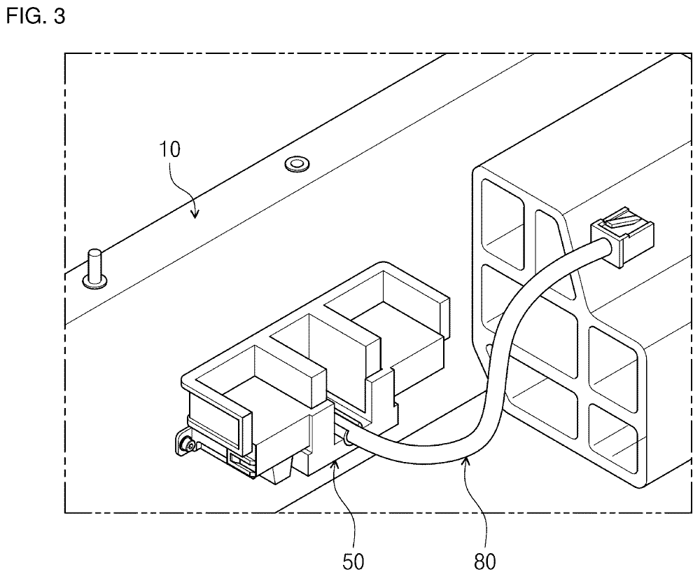

FIG. 1 is a disassembled diagram of a connector apparatus for a vehicle according to the disclosure, FIG. 2 is an assembled diagram of the connector apparatus of FIG. 1, and FIG. 3 is a diagram illustrating that a connector block is installed on a second side of a casing.

The connector apparatus for a vehicle according to the disclosure includes a casing 10 forming an outer appearance, a male connector 30 placed on a first side of the casing 10 and including a first coupler 40, and a connector block 50 placed on a second side of the casing 10, provided with an interlocking wire 80 and including a second coupler 60.

In an interlocking wire connection structure, the interlocking refers to a safety system for double-checking whether a high-voltage connector is connected or not, and has a structure for regularly checking whether two thin pins form a closed circuit so as to ensure the high-voltage connector is properly connected.

The casing 10 is formed with a through hole 14 through which the second coupler 60 passes, and the male connector 30 and the connector block 50 are arranged to be separated with the casing 10 interposed therebetween.

Meanwhile, the male connector 30 may be separated from the interlocking wire 80 and comes into contact with only the second coupler 60 through the through hole 14. That is, the male connector 30 is not in contact with the interlocking wire 80 or is not directly coupled to the interlocking wire 80. Therefore, even when the male connector 30 is separated from the casing 10, there is no need to separate the male connector 30 from the connector block 50 in consideration of the interlocking wire 80. Accordingly, there is no need to consider the position of the interlocking wire 80 or whether a high voltage is applied to the interlocking wire 80 while separating the male connector 30 or coupling the male connector 30, improving the safety of a worker and facilitating work.

As shown in FIGS. 1 and 3, the connector block 50 may be coupled to the second side, i.e., a second surface of the casing. The second side of the casing 10, i.e., the surface where the connector block 50 is installed may be sealed by the casing 10. That is, FIG. 3 shows a working environment where a worker cannot see the surface, on which the connector block 50 is installed, without disassembling the casing 10. In this case, according to the disclosure, a worker can separate the male connector 30 from the connector block 50 without disassembling the casing 10.

The interlocking wire 80 may be coupled penetrating the connector block 50. That is, the interlocking wire 80 is not easily separated from the connector block 50, thereby solving a problem that the interlocking wire 80 is separated from the connector block 50.

The second coupler 60 may be formed with a coupling groove 64, and the interlocking wire 80 may be disposed up to the coupling groove 64. The coupling groove 64 is formed inside the second coupler 60. Therefore, a first end of the interlocking wire 80 is fastened to the coupling groove 64, so that the interlocking wire 80 can couple with the connector block 50.

The coupling groove 64 may be disposed to extend up to the first side of the casing 10. As shown in FIG. 1, a first end of the coupling groove 64 may be formed to extend up to the first side of the casing 10 beyond the surface on which the connector block 50 is placed. Further, the first end of the interlocking wire 80 fastened to the coupling groove 64 may also be arranged to extend up to the first side of the casing 10 beyond the surface on which the connector block 50 is placed. In FIG. 1, the first end of the interlocking wire 80 is arranged to the left of the end surface of the casing 10.

The second coupler 60 is disposed protruding from the connector block 50 and inserted into the through hole 14 while passing through the through hole 14. The second coupler 60 protrudes more than the connector block 50 and is thus disposed to the left of the end surface of the casing 10 in the state that the connector block 50 is in contact with the casing 10. The second coupler 60 exposed as above is coupled to the first coupler 40, so that the male connector 30 and the connector block 50 can be coupled to each other.

That is, the second coupler 60 extends longer than the thickness of the casing 10 and thus protrudes to be exposed to the first side of the casing 10.

Meanwhile, there may be further provided a female connector 90 to couple with the male connector 30. The female connector 90 may be physically and electrically connected to the male connector 30.

The through hole 14 may be identical to the cross-section of the second coupler 60 and thus filled up without any empty space when the second coupler 60 is inserted into the through hole 14. Of course, the through hole 14 may have a tolerance to couple with the second coupler 60.

The through hole 14 may be smaller than the cross-section of the connector block 50 and thus restrict the connector block 50 from moving to the opposite side of the casing 10 through the through hole 14.

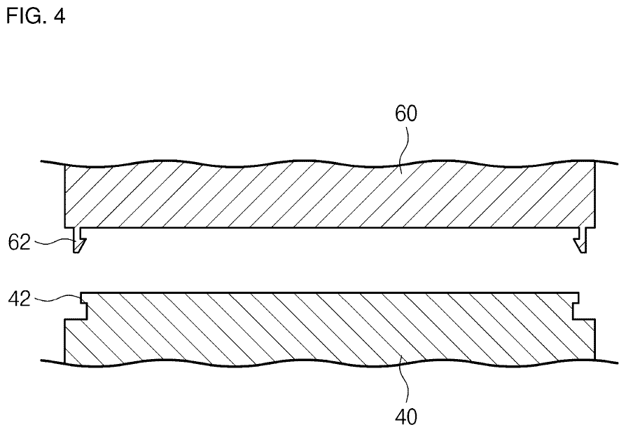

FIG. 4 is a diagram illustrating a first coupler and a second coupler.

As shown in FIG. 4, the second coupler 60 may include a hook 62, and the first coupler 40 may include a protrusion 42 to couple with the hook 62. Of course, FIG. 4 is merely an example, and various embodiments for coupling the first coupler and the second coupler may be selected.

On the rear of the protrusion 42, an insertion groove into which the hook 62 is inserted may be formed, thereby achieving a structure for fastening the male connector and the connector block safely.

According to the disclosure, an interlocking wire assembly process may be eliminated, thereby shortening a process cycle time and reducing costs due to the eliminated number of man-hours.

Further, when the connector is used for high voltage, the stability of the assembly may be ensured. When the connector is used for high voltage, there may be safety concerns such as a worker coming into contact with a high voltage part up on connecting the interlocking wire. However, according to the disclosure, a worker is not exposed to high voltage.

Furthermore, there is no need to consider the arrangement of the interlocking wire when coupling the male connector and the connector block, thereby decreasing the possibility of damage to the interlocking wire.

When the male connector needs to be replaced due to a trouble with the male connector, it is possible to replace the male connector without disassembling the casing.

The disclosure is not limited to the foregoing embodiments but may be modified by a person having ordinary knowledge in the field, to which the disclosure pertains, as can be seen from the appended claims, and such modifications fall within the scope of the disclosure.

Reference Numerals

| | |
|---|---|
| 10: casing | 14: through hole |
| 30: male connector | 40: first coupler |
| 50: connector block | 60: second coupler |
| 80: interlocking wire | 90: female connector |

What is claimed is:

1. A connector apparatus for a vehicle, the connector apparatus comprising:
a casing;
a male connector disposed on a first side of the casing, the male connector comprising a first coupler; and
a connector block disposed on a second side of the casing, and comprising a second coupler attached to an interlocking wire,
wherein the casing is formed with a through hole through which the second coupler passes,
wherein the male connector and the connector block are arranged to be separated with the casing interposed therebetween, and
wherein the male connector is separated from the interlocking wire and is configured to come in contact with the second coupler through the through hole.

2. The connector apparatus of claim 1, wherein the male connector is further configured to come in contact with only the second coupler through the through hole.

3. The connector apparatus of claim 1, wherein the second coupler is configured to protrude from the connector block and insert into the through hole while passing through the through hole.

4. The connector apparatus of claim 3 wherein the second coupler is configured to extend longer than the thickness of the casing and protrude to be exposed to the first side of the casing.

5. The connector apparatus of claim 1, wherein the second coupler is formed with a coupling groove, and
wherein the interlocking wire is configured to extend into the coupling groove.

6. The connector apparatus of claim 5, wherein the coupling groove is configured to extend to the first side of the casing.

7. The connector apparatus of claim 1, further comprising a female connector configured to couple with the male connector.

8. The connector apparatus of claim 1, wherein the interlocking wire is configured to couple to and penetrate the connector block.

9. The connector apparatus of claim 1, wherein a surface where the connector block is installed is sealed by the casing.

10. The connector apparatus of claim 1, wherein the second coupler comprises a hook, and
wherein the first coupler comprises a protrusion configured to couple with the hook.

11. The connector apparatus of claim 1, wherein the through hole is equivalent in size to a cross-section of the second coupler, and smaller than a cross-section of the connector block.

12. A connector system for a vehicle, the system comprising:
a casing including a through hole;
a male connector disposed on a first side of the casing, the male connector including a first coupler;
a connector block disposed on a second side of the casing and including a second coupler that extends through the through hole toward the male connector; and
an interlocking wire attached to the second coupler and extending through the connector block at the second side of the casing,
wherein the first coupler and the second coupler are configured to attach to each other to interconnect the male connector and the connector block, and
wherein the male connector and the connector block are separated by the casing interposed therebetween.

13. The system of claim 12, wherein the male connector is configured to come in contact with a portion of the second coupler that extends through the through hole.

14. The system of claim 12, wherein the first coupler and the second coupler are further configured to detachably attach to each other.

15. The system of claim 14, wherein the first coupler and the second coupler are attached via a connection that includes a hook, a coupling groove, and a protrusion.

16. The system of claim 14, wherein the first coupler includes the protrusion and the second coupler includes the protrusion and the insertion groove, and
wherein the hook is inserted into the coupling grove and interlocked with the protrusion.

17. The connector apparatus of claim 12, wherein the second coupler is formed with a coupling groove, and
wherein the interlocking wire is configured to extend into the coupling groove.

18. The connector apparatus of claim 12, further comprising a female connector configured to couple with the male connector.
